(19) United States
(12) Patent Application Publication
(10) Pub. No.: US 2026/0133394 A1
(43) Pub. Date: May 14, 2026

(54) BUCKLE TYPE FIXING ASSEMBLY FOR OPTICAL FILM

(71) Applicant: VICROUND LIMITED COMPANY, TAIPEI CITY (TW)

(72) Inventor: SHUI-CHIN CHEN, TAIPEI CITY (TW)

(21) Appl. No.: 18/944,287

(22) Filed: Nov. 12, 2024

(51) Int. Cl. G02B 7/00

(52) U.S. Cl. CPC G02B 7/006

(57) ABSTRACT

A buckle type fixing assembly for an optical film has a fixing member and a suspension member. The fixing member has a clamping protrusion. The suspension member has a buckle ring. The user may place multiple sets of the suspension members of the buckle type fixing assembly to the periphery of the optical film at intervals, then attaching the fixing member to the corresponding position on the frame of the monitor. The optical film can then be mounted in front of the display screen of the monitor or removed from the monitor by means of sleeving the buckle ring of each one of suspension members on the clamping protrusion of each one of the fixing members.

### BACKGROUND OF THE INVENTION

### 1. Field of the Invention

The present invention relates to a fixing assembly, especially to a buckle type fixing assembly that facilitates an optical film to be detachably mounted in front of a display screen.

### 2. Description of the Prior Arts

With the rapid development of the electronics industry and the internet, desktop computers, laptop computers, tablet computers and smart phones have become indispensable electronic products in contemporary life. For different purposes, users will purchase optical films with different functions to cover the display screen. For example, to protect the eyes, some people will purchase optical films with an anti-blue-light function; to guard work confidentiality or personal privacy, some people will purchase peek-proof optical films to limit the angle of viewing the content on the display screen, so that it is difficult for people around to peek at the display screen; to avoid the display screen from being damaged by impact or scratching, some people will purchase optical films with anti-scratch and anti-impact effects.

Most of the conventional optical films are mounted on the screens of desktop or laptop computers either by direct adhesion or by adding frames. If the optical film is fixed by direct adhesion, not only the optical film is hardly to be removed arbitrarily and replaced with an optical film with a different effect, but also the optical film will leave a residue of adhesive on the display screen or damage the surface structure of the optical film upon removal. By the frame that holds the optical film on the display screen, although the optical film can be removed from the display screen and replaced at any time, the optical film will be unable to be tightly fitted to the display screen, thereby affecting the clarity of the image displayed on the display screen.

To overcome the shortcomings, the present invention provides a buckle type fixing assembly to mitigate or obviate the aforementioned problems.

### SUMMARY OF THE INVENTION

The main objective of the present invention is to provide a buckle type fixing assembly of an optical film that allows the user to detachably install the optical film in front of the display screen, so that the optical film can be easily mounted and removed.

The buckle type fixing assembly for an optical film has a fixing member and a suspension member. The fixing member has a first positioning substrate, a clamping protrusion, and a first adhesive piece. The clamping protrusion is formed on an outer surface of the first positioning substrate. The first adhesive piece is mounted on an inner surface of the first positioning substrate.

The suspension member has a second positioning substrate, a buckle ring, an extending part, and a second adhesive piece. The buckle ring has a buckle hole and at least one groove. The clamping protrusion is detachably mounted through the buckle hole of the buckle ring. The at least one groove is formed on one surface of the buckle ring. The extending part protrudes laterally from a side edge of the second positioning substrate, and two ends of the extending part are respectively connected to the second positioning substrate and the buckle ring. The second adhesive piece is mounted on an inner surface of the second positioning substrate.

By means of the design as described above, the user may place multiple sets of the suspension members of the buckle type fixing assembly to the periphery of the optical film at intervals, then attaching the fixing member to the corresponding position on the frame of the monitor. The optical film can then be mounted in front of the display screen of the monitor or removed from the monitor by means of sleeving the buckle ring of each one of the suspension members on the clamping protrusion of each one of the fixing members. Therefore, the optical film can be easily operated no matter for installation or removal, without doing damage to the surface of the monitor or the surface structure of the optical film, while also facilitating the optical film to be tightly attached to the display screen of the monitor to ensure the clarity of the image displayed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a buckle type fixing assembly for an optical film in accordance with the present invention;

FIG. 2 is an exploded view of the buckle type fixing assembly in FIG. 1;

FIG. 3 is a perspective view of the buckle type fixing assembly in FIG. 1, shown in a state of use;

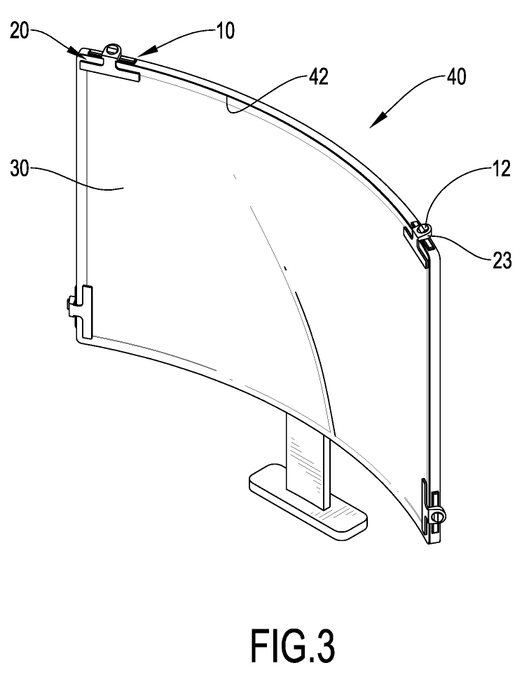

FIG. 4 is a perspective view of the buckle type fixing assembly in FIG. 1, shown in the state of use; and

FIG. 5 is a partial cross-sectional view of the buckle type fixing assembly in FIG. 1, shown in the state of use.

### DETAILED DESCRIPTION OF THE PREFERRED EMBODIMENTS

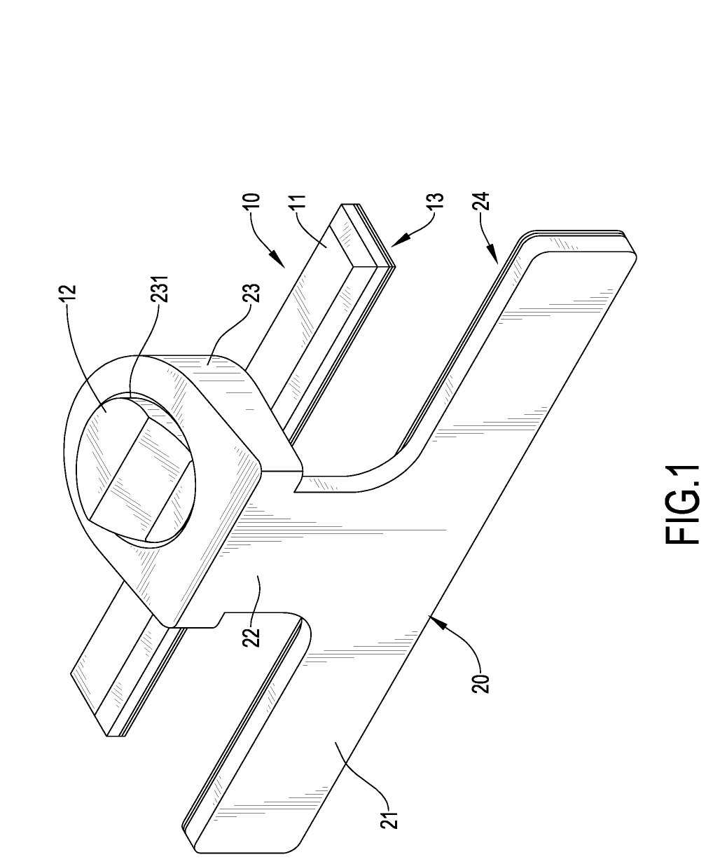

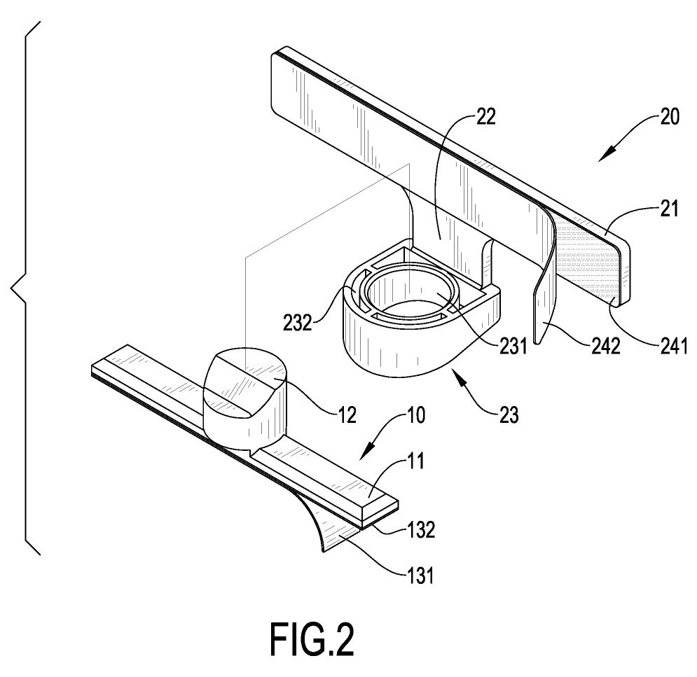

With reference to FIG. 1 and FIG. 2, a buckle type fixing assembly for an optical film in accordance with the present invention is configured to detachably mount an optical film 30 to a monitor 40, and the buckle type fixing assembly comprises a fixing member 10 and a suspension member 20.

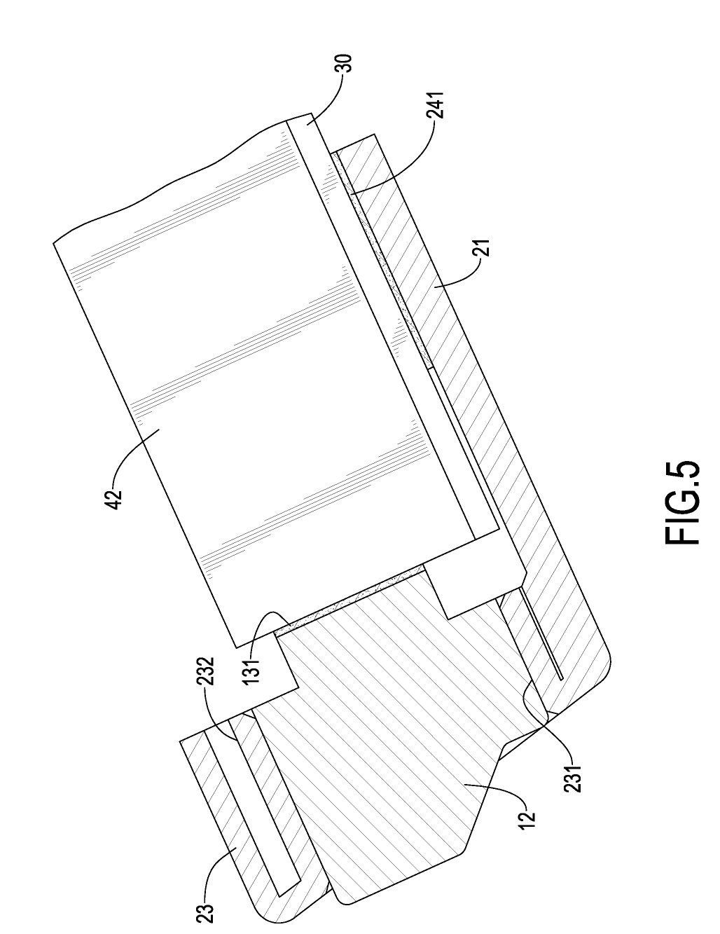

With reference to FIG. 1, FIG. 2 and FIG. 5, the fixing member 10 comprises a first positioning substrate 11, a clamping protrusion 12 and a first adhesive piece 13. The clamping protrusion 12 is formed on an outer surface of the first positioning substrate 11. The first adhesive piece 13 is mounted on an inner surface of the first positioning substrate 11.

Precisely, the first adhesive piece 13 comprises a fixing adhesive layer 131 and a fixing release film 132. The fixing adhesive layer 131 of the first adhesive piece 13 is mounted on the inner surface of the first positioning substrate 11, and the fixing release film 132 of the first adhesive piece 13 can be further detachably attached to the fixing adhesive layer 131 of the first adhesive piece 13. The user can remove the fixing release film 132 of the first adhesive piece 13, and then attach the fixing member 10 through the fixing adhesive layer 131 of the first adhesive piece 13 at a suitable position.

The suspension member 20 comprises a second positioning substrate 21, an extending part 22, a buckle ring 23 and a second adhesive piece 24. The extending part 22 protrudes laterally from a side edge of the second positioning substrate 21. Two ends of the extending part 22 are respectively connected to the second positioning substrate 21 and the buckle ring 23. The buckle ring 23 forms a bend relative to the extending part 22, and the buckle ring 23 forms a buckle hole 231 and at least one groove 232. The clamping protrusion 12 of the fixing member 10 is detachably mounted through the buckle hole 231. The at least one groove 232 is formed on one surface of the buckle ring 23. The second adhesive piece 24 is mounted on an inner surface of the second positioning substrate 21.

Precisely, the second adhesive piece 24 comprises a suspension adhesive layer 241 and a suspension release film 242. The suspension adhesive layer 241 of the second adhesive piece 24 is mounted on the inner surface of the second positioning substrate 21, and the suspension release film 242 of the second adhesive piece 24 can be further detachably attached to the suspension adhesive layer 241 of the second adhesive piece 24. The user can remove the suspension release film 242 of the second adhesive piece 24, and then attach the suspension member 20 through the suspension adhesive layer 241 of the second adhesive piece 24 at a suitable position.

With reference to FIG. 2 and FIG. 5, to mount the optical film 30 on the monitor 40, the user may first attach multiple sets of the suspension members 20 of the buckle type fixing assembly to the periphery of the optical film 30 via the second adhesive piece 24 at spaced intervals, then attaching the fixing members 10 of the buckle type fixing assemblies to the corresponding position on the frame 42 of the monitor 40 via the first adhesive pieces 13. Then, the user may sleeve the buckle ring 23 of each suspension member 20 of the optical film 30 on the clamping protrusion 12 of each fixing member 10 of the frame 42 of the monitor 40, so as to shield the optical film 30 in the front of the display screen 41 of the monitor 40.

For better use, the dimensional relationship between the clamping protrusion 12 of the fixing member 10 and the buckle hole 231 of the buckle ring 23 of the suspension member 20 is a “transitional fit”, precisely, the dimensional tolerance range of the radial width of the clamping protrusion 12 overlaps with the dimensional tolerance range of the radial width of the buckle hole 231, such that the clamping protrusion 12 and the buckle ring 23 can be securely connected. In addition, the aforementioned suspension member 20 can be made of a flexible and elastic plastic material. During the installation process, the extending part 22 and the buckle ring 23 of the suspension member 20 can be slightly bent and angled so as to sleeve on the clamping protrusion 12 of the fixing member 10 and to form an assembly effect similar to an interference, so as to enhance the stability of the assembly. Meanwhile, when the clamping protrusion 12 of the fixing member 10 is mounted in the buckle hole 231, the clamping protrusion 12 will support an inner wall of the buckle hole 231 toward the groove 232, so that the deformation from the engagement of the clamping protrusion 12 and buckle hole 231 can be limited in the groove 232, and the assembly relationship between the fixing member 10 and the suspension member 20 can be stabilized.

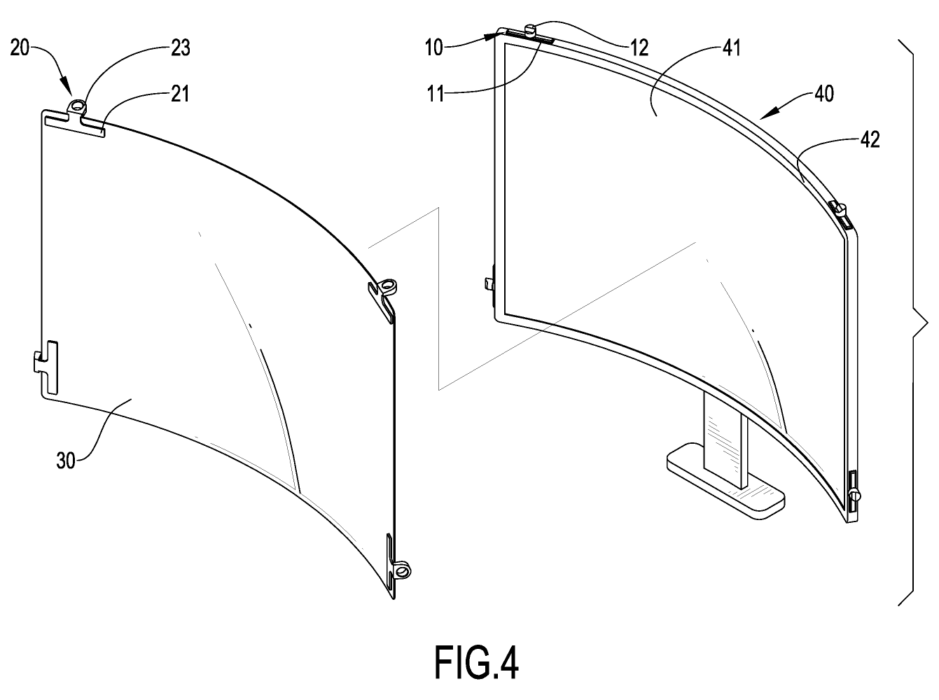

With reference to FIG. 4, the optical film 30 comprises an inner side surface and an outer side surface. The inner side surface of the optical film 30 faces toward the display screen 41 of the monitor 40. With reference to FIG. 2, in a better embodiment of the present invention, the buckle ring 23 of the suspension member 20 bends toward one side of the second positioning substrate 21 and the second adhesive piece 24 faces toward the same side of the second positioning substrate 21. When the present invention is in use, the second adhesive piece 24 attaches to the outer side surface of the optical film 30, so that the buckle ring 23 may sleeve on the corresponding clamping protrusion 12 of the fixing member 10. But it is not limited thereto, as the bending direction of the buckle ring 23 of the suspension member 20 and the facing direction of the second adhesive piece 24 also can be on the opposite sides of the second positioning substrate 21. In this configuration, the second adhesive piece 24 is configured to be attached to the inner side surface of the optical film 30, and the buckle ring 23 also can sleeve on the corresponding clamping protrusion 12 of the fixing member 10.

The advantage of the present invention is that the user can install the optical film 30 with a predetermined effect to the front of the display screen 41 of the monitor 40 or remove the optical film 30 from the monitor 40 according to the demand via the fixing member 10 and the suspension member 20. Therefore, the optical film 30 can be easily operated no matter for installation or removal without doing damage to the surface of the monitor 40 or the surface structure of the optical film 30, while also facilitating the optical film 30 to be tightly attached to the display screen 41 of the monitor 40 to ensure the clarity of the image displayed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A buckle type fixing assembly for an optical film comprising:
a fixing member comprising:
a first positioning substrate;
a clamping protrusion formed on and protruding from an outer surface of the first positioning substrate; and
a first adhesive piece mounted on an inner surface of the first positioning substrate; and
a suspension member comprising:
a second positioning substrate;
a buckle ring comprising:
a buckle hole, the clamping protrusion detachably threaded through the buckle hole of the buckle ring;
at least one groove formed on one surface of the buckle ring;
an extending part protruding from a side edge of the second positioning substrate, and two ends of the extending part respectively connected to the second positioning substrate and the buckle ring; and
a second adhesive piece mounted on an inner surface of the second positioning substrate.

2. The buckle type fixing assembly as claimed in claim 1, wherein, the buckle ring of the suspension member forms a bend relative to the extending part.

3. The buckle type fixing assembly as claimed in claim 2, wherein, the buckle ring of the suspension member bends toward a side of the second positioning substrate; the second adhesive piece faces toward the said side of the second positioning substrate.

4. The buckle type fixing assembly as claimed in claim 2, wherein, the buckle ring of the suspension member bends toward a side of the second positioning substrate; the second adhesive piece faces toward an opposite side of the second positioning substrate.

5. The buckle type fixing assembly as claimed in claim 1, wherein, a dimensional relationship between the clamping protrusion of the fixing member and the buckle hole of the buckle ring of the suspension member is a transition fit.

6. The buckle type fixing assembly as claimed in claim 3, wherein, a dimensional relationship between the clamping protrusion of the fixing member and the buckle hole of the buckle ring of the suspension member is a transition fit.

7. The buckle type fixing assembly as claimed in claim 4, wherein, a dimensional relationship between the clamping protrusion of the fixing member and the buckle hole of the buckle ring of the suspension member is a transition fit.

8. The buckle type fixing assembly as claimed in claim 1, wherein, the first adhesive piece of the fixing member comprises:
a fixing adhesive layer mounted on the inner surface of the first positioning substrate; and
a fixing release film detachably adhered to the fixing adhesive layer of the first adhesive piece.

9. The buckle type fixing assembly as claimed in claim 6, wherein, the first adhesive piece of the fixing member comprises:
a fixing adhesive layer mounted on the inner surface of the first positioning substrate; and
a fixing release film detachably adhered to the fixing adhesive layer of the first adhesive piece.

10. The buckle type fixing assembly as claimed in claim 7, wherein, the first adhesive piece of the fixing member comprises:
a fixing adhesive layer mounted on the inner surface of the first positioning substrate; and
a fixing release film detachably adhered to the fixing adhesive layer of the first adhesive piece.

11. The buckle type fixing assembly as claimed in claim 1, wherein, the second adhesive piece of the suspension member comprises:
a suspension adhesive layer mounted on the inner surface of the second positioning substrate; and
a suspension release film detachably adhered to the suspension adhesive layer of the second adhesive piece.

12. The buckle type fixing assembly as claimed in claim 9, wherein, the second adhesive piece of the suspension member comprises:
a suspension adhesive layer mounted on the inner surface of the second positioning substrate; and
a suspension release film detachably adhered to the suspension adhesive layer of the second adhesive piece.

13. The buckle type fixing assembly as claimed in claim 10, wherein, the second adhesive piece of the suspension member comprises:
a suspension adhesive layer mounted on the inner surface of the second positioning substrate; and
a suspension release film detachably adhered to the suspension adhesive layer of the second adhesive piece.
